(19) United States
(12) Patent Application Publication
(10) Pub. No.: US 2002/0009273 A1
(43) Pub. Date: Jan. 24, 2002

(54) Neutral wire for power distribution systems

(76) Inventors: Hiroji Akasaka, Rimouski (CA); Michel Huot, Rimouski (CA); Takashi Shinohara, Rimouski (CA); Tarlochan Singh, Pickering (CA); Carlton Choo-Wing, Pickering (CA); Tewfik Schehade, Toronto (CA)

Correspondence Address: PILLAY, Kevin, FASKEN MARTINEAU DuMOULIN LLP, Toronto Dominion Bank Tower, P.O.Box 20, Toronto-Dominion Centre, Suite 4200, Toronto, ON, M5K IN6, CA

(21) Appl. No.: 09/761,823

(22) Filed: Jan. 18, 2001

(30) Foreign Application Priority Data
Feb. 3, 2000 (CA) 2,297,876

(51) Int. Cl. G02B 6/44

(52) U.S. Cl. 385/113; 385/109

(57) ABSTRACT

At neutral or messenger wire for a power distribution system comprises a plastics tube supported by metal wires extending along the outside of the tube. Optical fibers arc located within the plastics tube and a coating is applied to the outside of the tube to enhance wear characteristics.

The present invention relates to neutral wires for use in an above ground power distribution systems.

Electrical power is distributed through conductors carried above ground on poles. Typically, the system will have one or more line conductors carrying AC at different phases and a neutral wire to provide a return path.

The service requirements for a neutral wire require it to be electrically conductive as well as self-supporting. In more recent years use has been made of the neutral wire to also carry a messenger wire so that information can be transmitted along the existing power distribution corridors. The wires have been located within a conductive, usually aluminum, tube which in turn is supported by wire strands that provide the tensile strength for the ground wire. It is also known to incorporate optical fibers with the messenger wire to increase the information carrying capacity.

Because the neutral wire is unsupported between the posts, it is subject to the normal mechanical forces due to its own inherent weight, wind and other atmospheric conditions such as ice build up. These mechanical forces are imposed on the wire strands and the aluminum tube which in turn transmit the forces through to the optic fibers.

To avoid the possibility of damage to any optical fibers used as messenger wires, it is known to arrange the fibers helically on a spacer within the tube. Such an arrangement is relatively expensive due to the need for the additional components and the need to assemble the fiber onto the spacer. As an alternative to a helical spacer it is also known to ensure that an excess length of fiber is provided within the tube so that as the tube is subjected to the elongation due to the mechanical forces, the strain is not passed through to the fiber.

The use of an aluminum tube protects the messenger wire from water and other environmental concerns. However, the aluminum tube is relatively weak in compression and therefore is unable to withstand the radial forces that might be imposed upon it during installation. To provide additional mechanical strength it has been proposed to utilize concentric rings of aluminum wires around the aluminum tube. Typically these wires are steel with an aluminum cladding adjacent the tube and an aluminum alloy as a second band of wires. The increased tensile and radial strengths avoid damage to the tube but at the same time increases the expense of the wire.

It is therefore an object of the present invention to provide a neutral wire in which the above disadvantages are obviated or mitigated.

In accordance with one aspect of the present invention there is provided a neutral wire for use in an above ground power distribution system. The neutral or messenger wire comprises an elongate plastics tube and at least one optical fiber freely moveable within said tube and having an overall length greater than the tube in a free body state. A plurality of metal wire strands are disposed about and extend along the length of said tube.

The provision of a plastic tube to house the optic fibers enables the requisite radial strength to be attained.

Preferably said tube is coated with a protective plastics coating of a dissimilar material.

An embodiment of the invention will now be described by way of example only with reference to the accompanying drawings in which:

FIG. 1 is a schematic illustration of a power distribution system.

FIG. 2 is a perspective view of a portion of the ground wire used in the power distribution system of FIG. 1.

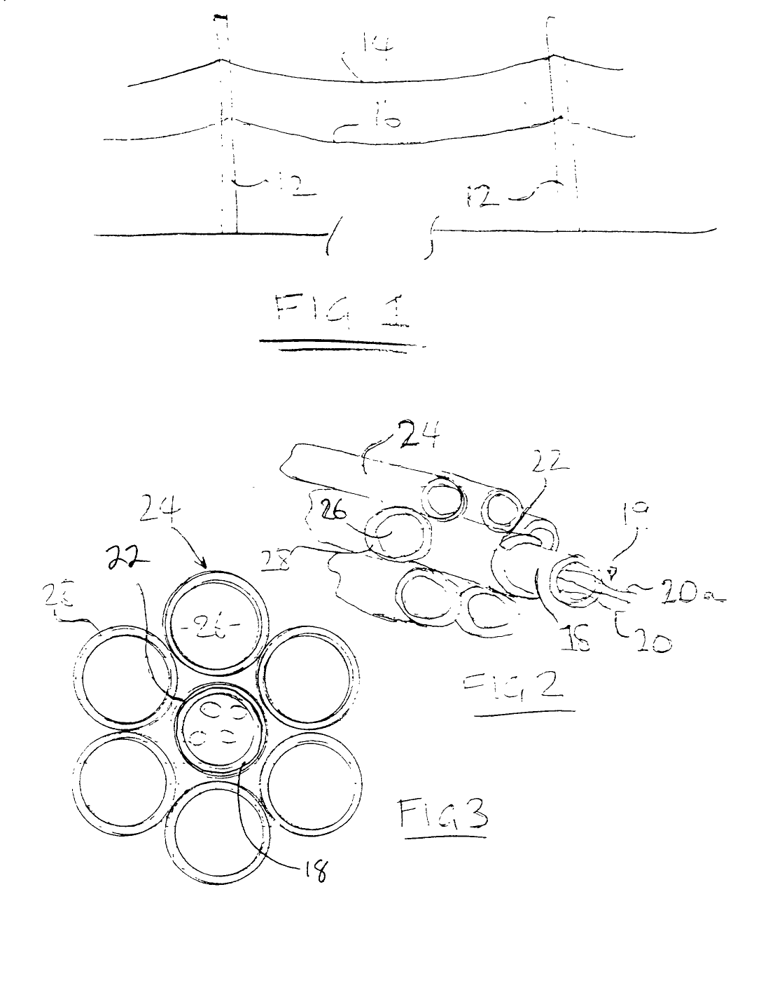

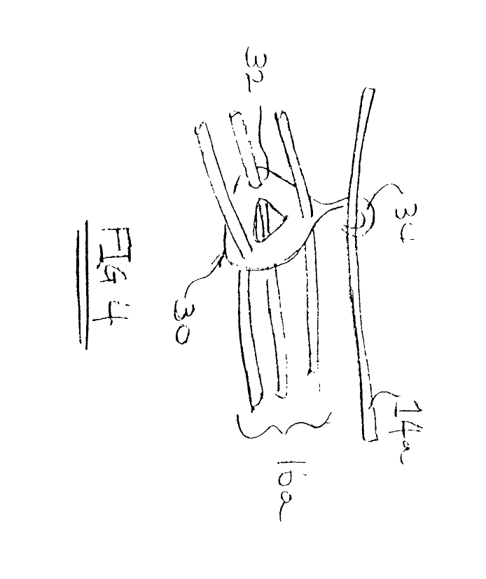

FIG. 3 is an end view of the ground wire shown in FIG. 2.

FIG. 4 is an enlarged view of a portion of an alternative embodiment of distribution system.

Referring therefore to FIG. 1, an electrical power distribution system generally indicated at 10 includes a pair of posts 12 supporting power conductors 14. Each of the conductors 14 carries an AC supply and are at different phases. A neutral wire 16; also referred to as a messenger wire, extends between the posts 12 below the conductors 14 and is fixed at each of the posts 12 by suitable clamps.

The neutral wire 16 is shown in more detail in FIGS. 2 and 3 and includes a plastics tube 18. A number of optic fibers 20 are located within the tube 18. The optic fibers are utilized to carry information and typically the tube will carry a significant number of fibers, sometimes upwards of 200. The fibers 20 are loosely located within the tube 18 and, in a free body state, have a length greater than that of the tube. The excess length of the fibers 20 will be at least 0.05% greater than that of the tube 18 although greater discrepancies may be used. In this way the tube 18 may elongate without inducing a corresponding strain upon the fibers 20.

An outer film or coating 22 is applied to the tube 18 to provide enhanced protection for the outer surface of the tube.

A plurality of wire strands 24 are helically wound around the outside of the tube 22. The strands 24 are typically a steel wire 26 having an aluminum coating 28 or are galvanized. Alternatively the strands are made entirely of an aluminum alloy. The strands 24 provide the requisite tensile strength for the tube to span between the posts 12 and provide a conductive path for electrical current.

The tube 18 is formed from a plastics material having a relatively high modulus of elongation to permit extension greater than 1% and typically in the order of 6%. The extension can be approximately 10 times the excess length of the fibers 20. The tube is formed from an engineering thermoplastic, typically polycarbonate, polybutylene terephtalate (PBT) polyethylene tetraphtalate (PET) or polyethylene naphthalate (PEN). In the preferred embodiment, tube 18 has a diameter of between 3 and 6 millimeters and a wall thickness of between 0.5 and 2.0 millimeter.

In a typical application the tube 18 has a diameter of 5.0 mm and a wall thickness of 0.8 mm.

The outer coating 22 is preferably a plastics material exhibiting good wear characteristics and resistance to environmental factors. Preferably polyethylene is used for the coating and applied at a thickness of 0.1 mm to 1.0 mm to give a diameter of between 3 and 7 mm.

The wire strands 24 are chosen to be of sufficient diameter and number to provide the tensile strength required for the span between the posts 12 and may if preferred be arranged in 2 annular bands.

In use, the plastic tube 18 has sufficient radial strength to withstand the radial loads imposed on the cable due to the clamping at the posts. At the same time the plastic tube provides protection for the fibers from water and ice and the excess length of the fibers in the tubes prevents strain being induced in the fibers when the ground wire is subject to mechanical loading.

It will be appreciated that the dimensions noted above with respect to the preferred embodiment are exemplary only and the individual components may be adjusted to suit the particular mechanical requirements of a given installation.

A further embodiment is shown in FIG. 4 where like reference numerals will be used to denote like components with a suffix ‘a’ added for clarity.

In the embodiment of FIG. 4, the conductors 16a are suspended from a neutral or messenger wire 14a by a hanger 30. The hanger 30 has spaced apertures 32 to receive one of the conductors 16a and a hook assembly 34. The hook assembly 34 engages the wire 14a to support the conductors 16a. The structure of the wire 14a is identical to that shown in FIGS. 2 and 3 with external wire strands wrapped extending along a plastic tube that holds a bundle of fibers.

The plastic tube 18 resists the radial loads imposed by the hook assembly 34 with the strands providing the requisite tensile strength.

We claim:

1. A neutral or messenger wire for use in an above ground power distribution system, said neutral wire comprising an elongate plastics tube, at least one optical fiber freely moveable within said tube and having an overall length not less than 0.05% greater than said tube in a free body state, and a plurality of metal wire strands disposed about said tube and extending along the length thereof.

2. A neutral wire according to claim 1 wherein a cladding is applied to said tube and is of a different plastics material.

3. A neutral wire according to claim 2 wherein said cladding is polyethylene.

4. A neutral wire according to claim 1 wherein said strands are aluminum alloy.

5. A neutral wire according to claim 1 wherein said strands are galvanized.

6. A neutral wire according to claim 1 wherein said strands have an aluminum cladding.

7. A neutral wire according to claim 5 wherein said tube is clad with a plastics material.

8. A neutral wire according to claim 1 wherein said plastic tube exhibits a longitudinal elasticity greater than 1%.

9. A neutral wire according to claim 1 wherein said plastic tube is formed from a plastic selected from the group consisting of polycarbonate, polybutylene terephtalate, polyethylene terphthalate and polyethylene napthalate.

10. A neutral wire according to claim 1 wherein said plastic tube has a wall thickness sufficient to withstand radial loads imposed thereon during installation.

11. A neutral wire according to claim 10 wherein said plastic tube has an outside diameter between 3 mm and 7 mm and a wall thickness of between 0.5 mm and 2 mm.

12. A neutral wire according to claim 11 wherein said plastic tube has a cladding of polyethylene.

13. A ground wire according to claim 12 wherein said polyethylene has a thickness of 0.1 mm to 1.0 mm.
